(19) United States
(12) Patent Application Publication
(10) Pub. No.: US 2012/0170428 A1
(43) Pub. Date: Jul. 5, 2012

(54) Adaptor to wear a pocket watch on a wrist

(76) Inventor: Ilia Boris Stavrovski, Prague (CZ)

(21) Appl. No.: 12/983,312

(22) Filed: Jan. 2, 2011

(51) Int. Cl. G04B 37/16

(52) U.S. Cl. 368/282

(57) ABSTRACT

A device (adaptor) for wearing a pocket watch on the wrist is disclosed.

The adaptor consists of a plate with rods (hooks) and lugs.

A pocket watch is mounted on the adaptor and fixed securely with rods (hooks). Watch wristband is attached to lugs to fasten the plate with attached pocket watch to a wrist to wear like a regular wristwatch. This is achieved without alterations to the pocket watch case, and the watches of different size could be used in the same adaptor.

### BACKGROUND OF THE INVENTION

In the beginning of the 20^{th} century the change in the pace of life and the change in the dress code led to the evolution of the pocket watch, which was awkward to wear and use, into the wristwatch, much easier to wear and use. The attempts were made to adopt existing pocket watches to wrist wear, including welding lugs to them, tying them by the key chain holder, putting them in pockets sewn to the wristbands. Eventually the current wristwatch as we know it evolved, with lugs being a part of its body,

### BRIEF SUMMARY OF THE INVENTION

The adaptor consists of a plate with rods (hooks) and lugs.

A pocket watch is mounted on the adaptor and fixed securely with rods (hooks). Watch wristband is attached to lugs to fasten the plate with attached pocket watch to a wrist to wear like a regular wristwatch.

To fix a pocket watch, either the distance between rods (hooks) is lessened by moving them closer together on a plate, or by moving parts of the plate together, or the rods (hooks) are bent. The rods (hooks) may be padded to prevent the watch case damage. The adaptor may have a ring to attach the pocketwatch ring to, to give additional protection against watch loss.

The method used in the adaptor is different from the one where the lugs are permanently attached to the body of the pocket watch by welding or other technique. The device does not damage the watch case, it can be removed, it can be used to wear a variety of different pocket watches of different size, both is not the case when permanently added lugs do not have these advantages.

Also, the adaptor is different from pockets sewed on to wristbands—it allows to see the full face of the pocket watch, holds the pocket watch firmly in place, displays the whole watch to the eye of the viewer and again is capable to accommodate watches of different sizes and forms.

### BRIEF DESCRIPTION OF THE SEVERAL VIEWS OF THE DRAWING

FIG. 1/2 shows three views of the adaptor with all the main parts of the adaptor shown—plate, lugs, rods (hooks)

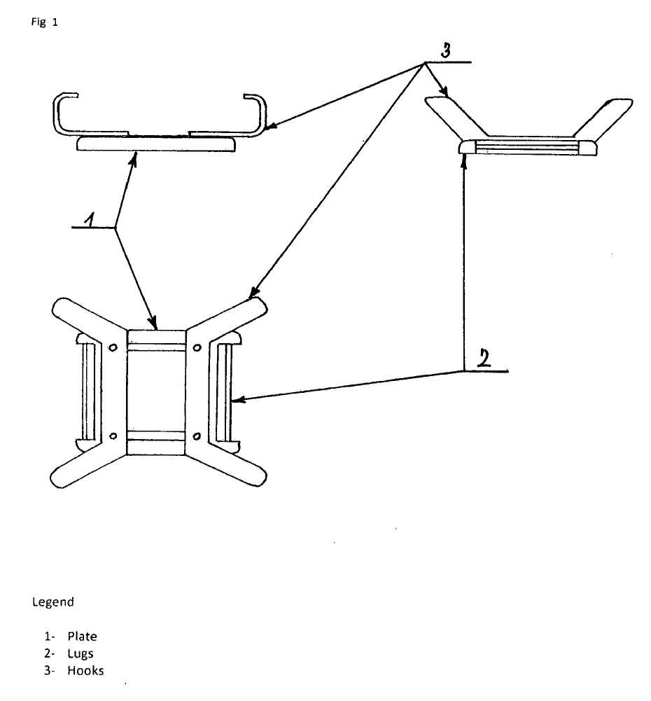

FIG. 2/2 shows a view of the empty adaptor on the human wrist (view 1) and a view of the adaptor holding a pocket watch on a human wrist

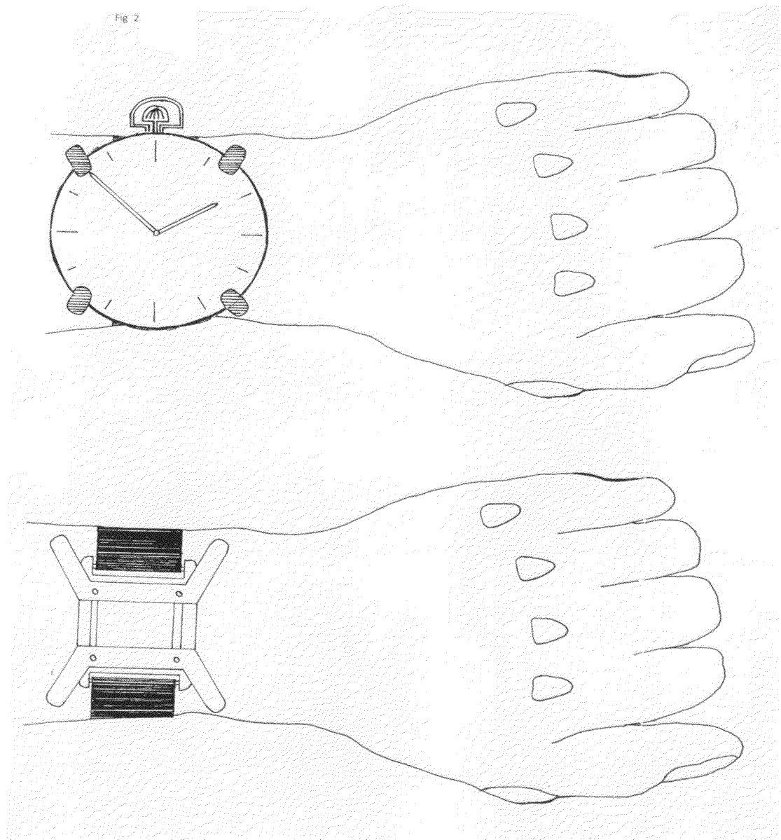

### THE DETAILED DESCRIPTION

The adaptor to wear a pocket watch on a wristband or bracelet consists of the lugs, that serve for attaching the wristband or the bracelet, the holders (rods, hooks) that hold the watch, and the foundation(plate), that holds the holders (rods, hooks) together.

The position of the holders (rods, hooks) against the lugs can be changed, thus allowing for holding a wristwatch of a different size and form, and for fixing the watch and the adaptor and for taking it out. The change of the position of holders is made by either attaching them to different parts of foundation, that can be moved against each other, or moving them individually on a fixed foundation. The fix of the position is reached by screws or other available techniques.

To achieve a firm hold of a watch by the holders, the minimum amount of holders is 3, the optimum is 4, but designs with more holders are possible, for firmer hold and more interesting look.

The variation of design, where the change of holders position against the foundation is possible, and achieved by implementing flexible holders, made of flexible material.

Lugs may be attached to a foundation by a variety of techniques, including, but not limited to: welding, producing them out of the same piece of material as foundation, etc.

All parts of the adaptor may be manufactured from different metal, wood, plastic, or other materials. All parts of the adaptor may be designed in different style to compliment the style of the pocket watch.

Holders may be padded with soft material to protect the watch from the damage from the holders.

The adaptor is revolutionary in wearing a pocket watch on a wristband or bracelet,

because it allows to display the pocket watch in all it's beauty without covering large portions of

[symbol]

it does not require any changes to the case of the pocket watch

[symbol]

May accommodate watches of different sizes and forms, thus allowing the owner of several watches to wear them in turns, with only seconds needed to change one watch in the adaptor for another.

What claimed is

1. The device (adaptor) for wearing a pocket watch on a wrist, by fixing it with holders (hooks, rods) and fastening adaptor on the wrist by bracelet or wristband, attached to adaptor lugs

2. The device claimed in 1, when the bracelet is the integral part of the device
